(19) United States
(12) Patent Application Publication
(10) Pub. No.: US 2026/0221690 A1
(43) Pub. Date: Jul. 30, 2026

(54) CONNECTOR WITH ENGAGEMENT FEATURES

(71) Applicant: Hall Research Technologies, Inc., Coppell, TX (US)

(72) Inventor: Brandon Gramse, Lewisville, TX (US)

(21) Appl. No.: 19/038,016

(22) Filed: Jan. 27, 2025

(51) Int. Cl. H01R 13/631

(52) U.S. Cl. CPC H01R 13/631; H01R 2201/06

(57) ABSTRACT

A peripheral connector includes a body and a set of connection features. The body includes an inner surface, an outer surface, and a set of recesses. The outer surface is opposite the inner surface. The set of recesses are formed in the outer surface. The set of connection features extend outwardly from the body. Each connection feature of the set of connection features is disposed above the outer surface. Each connection feature of the set of connection features includes a first end and a second end opposite the first end. For each connection feature, the first end and the second end are integrally formed in the outer surface. Each connection feature of the set of connection features is disposed above and spans across a corresponding recess of the set of recesses. Each connection feature of the set of connection features at least partially covers the corresponding recess.

### FIELD

The present disclosure relates to an electronic peripheral connector. More particularly, the present disclosure relates to an electronic peripheral connector with engagement features.

### BACKGROUND

Peripheral connectors, like Universal Serial Bus Type C (USB-C) connectors, connect a wide range of electronic devices (e.g., computers, phones, tablets, video game consoles, speakers, lights, etc.). These connectors provide data and power transmission for electronic devices. One challenge associated with peripheral connectors is ensuring that connectors remain securely connected to a peripheral port, thereby ensuring connection between two electronic devices. A loosely connected or disconnected connector will not transfer power and data to the electronic device. In view of the foregoing, improvements are needed to ensure secure connection of peripheral connectors.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the present disclosure provides a peripheral connector. The peripheral connector includes a body and a set of connection features. The body includes an inner surface, an outer surface, and a set of recesses. The outer surface is opposite the inner surface. The set of recesses are formed in the outer surface. The set of connection features extend outwardly from the body. Each connection feature of the set of connection features is disposed above the outer surface. Each connection feature of the set of connection features includes a first end and a second end opposite the first end. For each connection feature, the first end and the second end are integrally formed in the outer surface. Each connection feature of the set of connection features is disposed above and spans across a corresponding recess of the set of recesses. Each connection feature of the set of connection features at least partially covers the corresponding recess.

Another aspect of the present disclosure provides a peripheral connector. The peripheral connector includes a body and a set of connection features. The body defines a central axis. The body includes at least one wall and a set of recesses. The at least one wall surrounds the central axis. The set of recesses are formed in the at least one wall. The set of connection features extend outwardly from the body. Each connection feature of the set of connection features is disposed above the at least one wall. Each connection feature of the set of connection features includes a first end and a second end opposite the first end. For each connection feature, the first end and the second end are integrally formed in the at least one wall. Each connection feature of the set of connection features is disposed above and spans across a corresponding recess of the set of recesses. Each connection feature of the set of connection features at least partially covers the corresponding recess.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of a connector system in a first position according to an exemplary embodiment.

FIG. 2 is a perspective view of the connector system in a second position according to an exemplary embodiment.

FIG. 3 is a perspective view of a bottom side of a connector according to an exemplary embodiment.

In the drawings, reference numbers may be reused to identify similar and/or identical elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

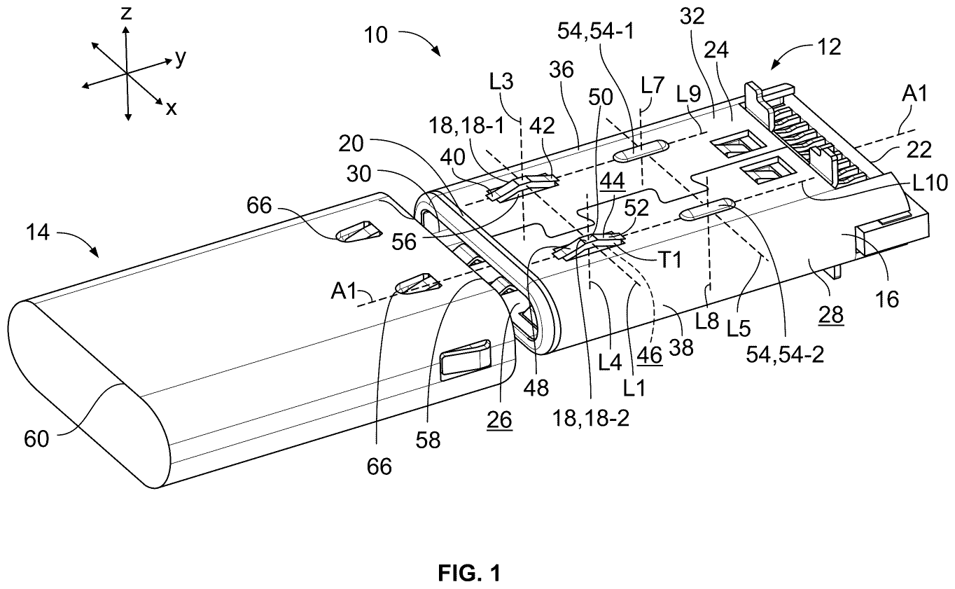

With reference to FIG. 1, a connector system 10 is illustrated. As will be explained in more detail below, the connector system 10 may be used to transmit power and/or data to and from a wide variety of electronic devices (not shown), such as computers, phones, tablets, video game consoles, speakers, lights, screens, or any other type of electronic device.

The connector system 10 may include a first connector 12 and a second connector 14. The second connector 14 may engage (e.g., receive, couple to, etc.) the first connector 12. In this regard, the first connector 12 may be a male or female connector, and the second connector 14 may be the other of a male or female connector. In some implementations, the first connector 12 is a male connector and the second connector 14 is a female connector. The first connector 12 and/or the second connector 14 may be any type of connector capable of power and/or data transmission (e.g., electrical peripheral connectors). For example, the first connector 12 and/or the second connector 14 may be a Universal Serial Bus (USB) connector, a USB Type C (USB-C) connector, a micro USB connector, an ethernet connector, a High-Definition Multimedia Interface (HDMI) connector, a DisplayPort (DP) connector, a mini DP connector, a Thunderbolt connector, a Video Graphics Array (VGA) connector, a Digital Visual Interface connector, or any other type of connector. In some implementations, the first connector 12 and the second connector 14 are the same type of connector. In some implementations, the first connector 12 is a male USB-C connector and the second connector 14 is a female USB-C connector.

The first connector 12 may include a body 16 and a set of connection features 18. The body 16 may include the set of connection features 18.

The body 16 may extend along a longitudinal (e.g., central) axis A1 (e.g., in the Y-direction) and may include a first end 20, a second end 22, and at least one wall 24. The at least one wall 24 may extend from the first end 20 to the second end 22 and surround the axis A1. The second end 22 may be opposite the first end 20. The at least one wall 24 may include an inner surface 26 and an outer surface 28. The outer surface 28 may be opposite the inner surface 26. In some implementations, the at least one wall 24 forms an opening 30 in the first end 20 of the body 16. In this regard, the opening 30 may be at least partially defined by the inner surface 26. In some implementations, the opening 30 has a stadium-shaped (e.g., a rectangle with semicircles at a pair of opposite sides) cross-sectional area. However, the opening 30 may have any other shaped cross-sectional area within the scope of the present disclosure.

In some implementations, the at least one wall 24 includes an upper wall 32, a lower wall 34, a first side wall 36, and a second side wall 38. Each of the upper wall 32, the lower wall 34, the first side wall 36, and the second side wall 38 may extend from the first end 20 to the second end 22. The lower wall 34 may be opposite the upper wall 32. The first side wall 36 may be opposite the second side wall 38. Each of the first side wall 36 and the second side wall 38 may extend between the upper wall 32 and the lower wall 34. In some implementations, the first side wall 36 and the second side wall 38 have a semicircular cross-sectional shape. In some implementations, the upper wall 32, the lower wall 34, the first side wall 36, and the second side wall 38 define the opening 30. While the body 16 is shown and described as having four walls, it will be appreciated, that the body 16 may have more or less than four walls within the scope of the present disclosure.

The body 16 may be formed from one or more of a variety of materials, including, for example, aluminum, steel, stainless steel, or another suitable metal material. The body 16 may shield internal electrical components (not shown) of the first connector 12 from electromagnetic interference and/or radiofrequency interference.

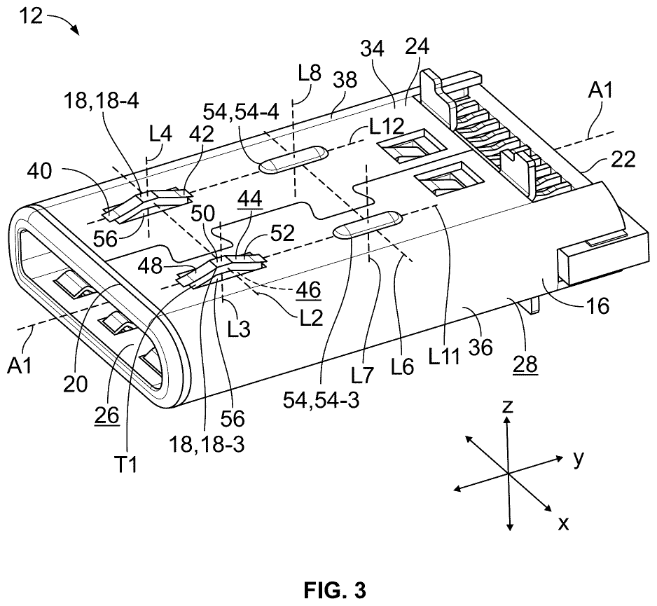

With reference to FIGS. 1 and 3, the set of connection features 18 may extend (e.g., in the Z-direction) from the at least one wall 24 of the body 16. In some implementations, the set of connection features 18 extends from the upper wall 32 and/or the lower wall 34. In the example shown in FIGS. 1 and 3, a first plurality of the set of connection features 18 may extend from the upper wall 32 and a second plurality of the set of connection features 18 may extend from the lower wall 34.

In the example shown in FIG. 1, the first plurality of the set of connection features 18 may be disposed proximate the first end 20 of the body 16. The first plurality of the set of connection features 18 may include a first connection feature 18-1 and a second connection feature 18-2. The first connection feature 18-1 and the second connection feature 18-2 may be collinear along a first line L1. The first line L1 may extend substantially (e.g., +/−20 degrees) parallel to the X-direction. In this regard, the first line L1 may be substantially (e.g., +/−20 degrees) parallel to the first end 20 of the body 16.

In the example shown in FIG. 3, the second plurality of the set of connection features 18 may be disposed proximate the first end 20 of the body 16. The second plurality of the set of connection features 18 may include a third connection feature 18-3 and a fourth connection feature 18-4. The third connection feature 18-3 and the fourth connection feature 18-4 may be collinear along a second line L2. The second line L2 may extend substantially (e.g., +/−20 degrees) parallel to the X-direction. In this regard, the second line L2 may be substantially (e.g., +/−20 degrees) parallel to the first end 20 of the body 16. In some implementations, the second line L2 is parallel to the first line L1. Referring to FIGS. 1 and 3, the first connection feature 18-1 and the third connection feature 18-3 may be collinear along a third line L3. Likewise, the second connection feature 18-2 and the fourth connection feature 18-4 may be collinear along a fourth line L4. Each of the third line L3 and the fourth line L4 may extend substantially (e.g., +/−20 degrees) parallel to the Z-direction. In some implementations, the third line L3 is parallel to the fourth line L4.

Each connection feature 18 of the set of the connection features 18 may be integrally formed in the at least one wall 24 (e.g., the outer surface 28). In this regard, each connection feature 18 may include a first end 40, a second end 42, a first surface 44, and a second surface 46. The second end 42 may be opposite the first end 40. The first end 40 and the second end 42 may connect to and extend from the outer surface 28, such that the connection feature 18 (e.g., the first surface 44) and the outer surface 28 form a continuous surface. In this regard, the connection feature(s) 18 may be monolithically formed with the body 16 (e.g., the at least one wall 24). The monolithic and/or integral construct of the connection feature(s) 18 may be created by one or more of a casting, forging, machining, or welding process performed on the body 16.

The second surface 46 may be opposite the first surface 44. The first surface 44 and the second surface 46 may extend from the first end 40 to the second end 42, such that the first surface 44 and the second surface 46 define a thickness T1 extending therebetween in a direction substantially perpendicular to the first surface 44 and the second surface 36. In some implementations, the thickness T1 is uniform along the connection feature(s) 18. It will be appreciated, however, that the thickness T1 may vary along the connection feature(s) 18.

Each connection feature 18 of the set of the connection features 18 may extend outwardly from the body 16 (e.g., the at least one wall 24) in the Z-direction. In this regard, at least a portion of the first surface 44 may be disposed above the outer surface 28. In some implementations, both the first surface 44 and the second surface 46 are at least partially disposed above the outer surface 28. In some implementations, the connection feature 18 includes a first portion 48, a second portion 50, and a third portion 52. Both the first portion 48 and the third portion 52 may connect the second portion 50 to the body 16 (e.g., the at least one wall 24). The second portion 50 may extend in a first direction substantially (e.g., +/−20 degrees) parallel to the at least one wall 24 (e.g., the Y-direction). The first portion 48 may extend in a second direction transverse to the first direction. The third portion 52 may extend in a third direction transverse the first direction and/or the second direction.

While each connection feature 18 is shown and described as having three portions, it will be appreciated that each connection feature 18 may have more or less than three portions extending in any number of directions within the scope of the present disclosure. For example, each connection feature 18 may have an arch shape (e.g., a rounded arch, a pointed arch, a triangular arch, etc.) within the scope of the present disclosure. Each connection feature 18 may have a different shape than one or more of the other connection features of the set of connection features 18. While a first implementation of the connection feature 18 is shown and described, it will be appreciated that connection feature 18 may be of any shape, size, and/or design that allows the connection feature 18 to extend from the at least one wall 24 and impart a force on the second connector 14 within the scope of the present disclosure. For example, the connection feature 18 may be a protrusion (e.g., a hemispherical, conical, frustoconical, or any other shaped protrusion).

The shape and/or thickness T1 of the connection feature(s) 18 may allow the connection feature 18 to move (e.g., flex) in the Z-direction when the connection feature 18 engages another connector (e.g., the second connector 14). In this regard, connection feature 18 may act in a spring-loaded manner where, when the first connector 12 is disposed within the second connector 14, the connection feature 18 imparts a force (e.g., a normal force) on the second connector 14. In this regard, the connection feature 18 does not deform when it engages the second connector 14, but instead springs-back. The force imparted by the connection feature 18 increase the frictional force between the first connector 12 and the second connector 14 ensuring a more secure fit between the connectors 12, 14 (e.g., it is harder to separate the connectors 12, 14) than if the first connector 12 did not have connection features. Since the connection feature 18 simply imparts a force on the second connector 14, the connection feature 18 may work (e.g., interface, engage) with the second connector 14 regardless of the design of the second connector 14. In other words, the second connector 14 does not need a corresponding connection feature that mates with the connection feature 18 in order for the connection feature 18 to provide a secure fit between the connectors 12, 14. The design of the connection feature 18 may allow the first connector 12 to work (e.g., interface, engage) with any currently available female connector. However, the second connector 14 may include a corresponding connection feature (e.g., a recess, detent, etc.) that receives the connection feature 18, thereby increasing the frictional force between the first connector 12 and the second connector 14 ensuring a more secure fit between the connectors 12, 14 (e.g., it is harder to separate the connectors 12, 14) than if the second connector 14 did not have a corresponding connection feature within the scope of the present disclosure.

In some implementations, the first connector 12 includes a set of protrusions 54. The set of protrusions 54 may be formed in the body 16. In this regard, the set of protrusions 54 may include one or more protrusions 54 extending (e.g., in the Z-direction) from the at least one wall 24 of the body 16. In some implementations, the set of protrusions 54 extends from the upper wall 32 and/or the lower wall 34. In the example shown in FIGS. 1 and 3, a first plurality of the set of protrusions 54 may extend from the upper wall 32 and a second plurality of the set of protrusions 54 may extend from the lower wall 34.

In the example shown in FIG. 1, the first plurality of the set of protrusions 54 may be disposed proximate the second end 22 of the body 16. The first plurality of the set of protrusions 54 may include a first protrusion 54-1 and a second protrusion 54-2. The first protrusion 54-1 and the second protrusion 54-2 may be collinear along a fifth line L5. The fifth line L5 may extend substantially (e.g., +/−20 degrees) parallel to the X-direction. In this regard, the fifth line L5 may be substantially (e.g., +/−20 degrees) parallel to the second end 22 of the body 16. In some implementations, the fifth line L5 is parallel to the first line L1.

In the example shown in FIG. 3, the second plurality of the set of protrusions 54 may be disposed proximate the second end 22 of the body 16. The second plurality of the set of protrusions 54 may include a third protrusion 54-3 and a fourth protrusion 54-4. The third protrusion 54-3 and the fourth protrusion 54-4 may be collinear along a sixth line L6. The sixth line L6 may extend substantially (e.g., +/−20 degrees) parallel to the X-direction. In this regard, the sixth line L6 may be substantially (e.g., +/−20 degrees) parallel to the second end 22 of the body 16. In some implementations, the sixth line L6 is parallel to the fifth line L5. Referring to FIGS. 1 and 3, the first protrusion 54-1 and the third protrusion 54-3 may be collinear along a seventh line L7. Likewise, the second protrusion 54-2 and the fourth protrusion 54-4 may be collinear along an eighth line L8. Each of the seventh line L7 and the eighth line L8 may extend substantially (e.g., +/−20 degrees) parallel to the Z-direction. In some implementations, the seventh line L7 is parallel to the eighth line L8.

The first connection feature 18-1 and the first protrusion 54-1 may be collinear along a ninth line L9 that extends substantially (e.g., +/−20 degrees) parallel to the Y-direction. The second connection feature 54-2 and the second protrusion 20-2 may be collinear along a tenth line L10 that extends substantially (e.g., +/−20 degrees) parallel to the Y-direction. The third connection feature 18-3 and the third protrusion 54-3 may be collinear along an eleventh line L11 that extends substantially (e.g., +/−20 degrees) parallel to the Y-direction. The fourth connection feature 18-4 and the fourth protrusion 54-4 may be collinear along a twelfth line L12 that extends substantially (e.g., +/−20 degrees) parallel to the Y-direction. In some implementations, the lines L9, L10, L11, and L12 are parallel to one another.

Each protrusion 54 of the set of protrusions 54 may extend from the body 16 (e.g., the at least one wall 24) in the Z-direction. Each protrusion 54 may have a half-capsule shape. In other words, the protrusion(s) 54 may have a stadium-shaped (e.g., a rectangle with semicircles at a pair of opposite sides) cross-sectional area. In some implementations, the protrusion(s) 54 and the body 16 (e.g., the at least one wall 24) may form a monolithic and/or integral construct.

While a first implementation of the protrusion 54 is shown and described herein as having a stadium shape, it will be appreciated, however, that the protrusion may have any other shape within the scope of the present disclosure. For example, the protrusion 54 may be a hemispherical, conical, or frustoconical protrusion. In some implementations, the protrusion 54 is be ramp-shaped. In some implementations, the protrusion 54 has a nodular shape.

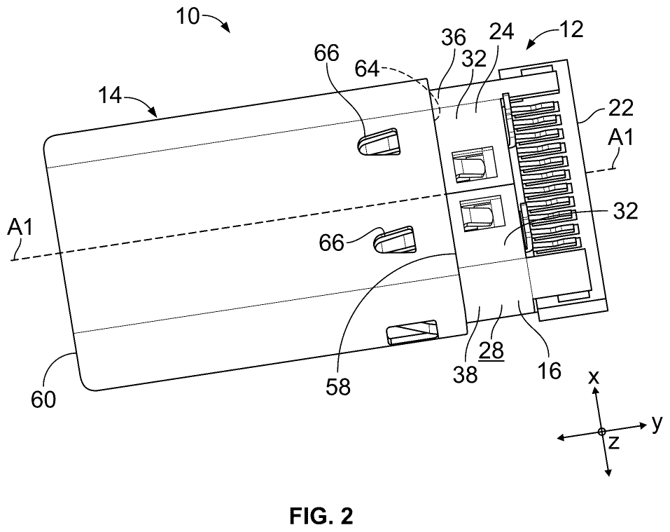

The protrusion(s) 54, like the connection features 18, may engage the second connector 14 to help provide a secure fit between the connectors 12, 14 in an assembled configuration (FIG. 2). In some implementations, the protrusion(s) 54 may engage a corresponding feature on the second connector 14. It will be appreciated, however, that the protrusion(s) 54, like the connection features 18, may work (e.g., interface, engage) with the second connector 14 regardless of the design of the second connector 14. In other words, the second connector 14 does not need a corresponding feature that mates with the protrusion(s) 54 in order for the protrusion(s) 54 to help provide a secure fit between the connectors 12, 14.

The outer surface 28 may define a set of recesses 56. Each recess 56 of the set of recesses 56 may be disposed beneath a corresponding connection feature 18. In some implementations, the recesses 56 may extend through the inner surface 26. The recesses 56 may facilitate movement (e.g., flexing) of the connection features 18 in one or more directions (e.g., the Z-direction). For example, the connection feature 18 may flex downwardly towards the recess 56. In some implementations, the connection feature 18, even when flexed (e.g., by contacting the second connector 14), does not recess into the body 16 (e.g., into the recess 56). In this regard, even when flexed, the first surface 44 of the connection feature 18 may remain disposed above the outer surface 28. However, in some implementations, the connection feature 18 at least partially recesses into the body 16 when the connection feature 18 is flexed. In some implementations, the connection feature 18 completely recesses into the body 16 when the connection feature 18 is flexed.

The connection feature 18 may span across the recess 56. The connection feature 18 may at least partially cover the recess 56 (e.g., the cross-sectional area of the recess 56). In some implementations, the connection feature 18 covers between 25% and 75% of the recess 56. For example, the connection feature 18 may cover 50% of the recess 56. In some implementations, the connection feature 18 completely covers the recess 56. In some implementations, the recess 56 is square shaped. The recess 56 may also have any other shape (e.g., circle, oval, rectangle, etc.) within the scope of the present disclosure.

The second connector 14 may include a first end 58, a second end 60, and an outer surface 62. The first end 58 may be opposite the second end 60. The outer surface 62 may extend between the first end 58 and the second end 60. In some implementations, the second connector includes an opening 64. The opening 64 may be sized to receive the first connector 12.

In some implementations, the second connector includes a set of openings 66. The set of openings 66 may receive the set of protrusions 20.

In an assembled configuration (FIG. 2), the set of connection features 18 and/or the set of protrusions 20 may engage the inner surface 62. In some implementations, the set of protrusions 20 are disposed within the set of openings 66 in the assembled configuration (FIG. 2).

### CONCLUSION

The following Clauses provide an exemplary configuration for a connector, as described above.

Clause 1: A peripheral connector comprising: a body including: an inner surface; an outer surface opposite the inner surface; and a set of recesses formed in the outer surface; and a set of connection features extending outwardly from the body, wherein: each connection feature of the set of connection features is disposed above the outer surface, each connection feature of the set of connection features includes a first end and a second end opposite the first end, for each connection feature, the first end and the second end are integrally formed in the outer surface, each connection feature of the set of connection features is disposed above and spans across a corresponding recess of the set of recesses, and each connection feature of the set of connection features at least partially covers the corresponding recess.

Clause 2: The peripheral connector of clause 1, wherein, even when flexed, each connection feature of the set of connection features remains disposed above the outer surface.

Clause 3: The peripheral connector of clause 1 or 2, wherein each connection feature of the set of connection features covers 50% of the corresponding recess.

Clause 4: The peripheral connector of any of clauses 1 through 3, wherein each recess of the set of recesses extends through the inner surface.

Clause 5: The peripheral connector of any of clauses 1 through 4, wherein each connection feature of the set of connection features defines a thickness that allows each connection feature to flex upon engaging a corresponding connector.

Clause 6: The peripheral connector of clause 5, wherein, when engaged with the corresponding connector, each connection feature of the set of connection features imparts a force on the corresponding connector.

Clause 7: The peripheral connector of any of clauses 1 through 6, wherein: the peripheral connector includes a first side and a second side opposite the first side, and the set of connection features includes a first connection feature formed in the first side and a second connection feature formed in the second side.

Clause 8: The peripheral connector of clause 7, wherein the set of connection features includes: a third connection feature formed in the first side, and a fourth connection feature formed in the second side.

Clause 9: The peripheral connector of any of clauses 1 through 8, further including a set of protrusions formed in the outer surface, wherein the set of protrusions includes a first protrusion and a second protrusion.

Clause 10: The peripheral connector of any of clauses 1 through 9, wherein the peripheral connector is a USB-C connector.

Clause 11: A peripheral connector comprising: a body defining a central axis, the body including: at least one wall surrounding the central axis; and a set of recesses formed in the at least one wall; and a set of connection features extending outwardly from the body, wherein: each connection feature of the set of connection features is disposed above the at least one wall, each connection feature of the set of connection features includes a first end and a second end opposite the first end, for each connection feature, the first end and the second end are integrally formed in the at least one wall, each connection feature of the set of connection features is disposed above and spans across a corresponding recess of the set of recesses, and each connection feature of the set of connection features at least partially covers the corresponding recess.

Clause 12: The peripheral connector of clause 11, wherein, even when flexed, each connection feature of the set of connection features remains disposed above the at least one wall.

Clause 13: The peripheral connector of clause 11 or 12, wherein each connection feature of the set of connection features covers 50% of the corresponding recess.

Clause 14: The peripheral connector of any of clauses 11 through 13, wherein each recess of the set of recesses extends through the at least one wall.

Clause 15: The peripheral connector of any of clauses 11 through 14, wherein each connection feature of the set of connection features defines a thickness that allows each connection feature to flex upon engaging a corresponding connector.

Clause 16: The peripheral connector of clause 15, wherein, when engaged with the corresponding connector, each connection feature of the set of connection features imparts a force on the corresponding connector.

Clause 17: The peripheral connector of any of clauses 11 through 16, wherein: the at least one wall includes an upper wall and a lower wall opposite the upper wall, and the set of connection features includes a first connection feature formed in the upper wall and a second connection feature formed in the lower wall.

Clause 18: The peripheral connector of clause 17, wherein the set of connection features includes: a third connection feature formed in the upper wall, and a fourth connection feature formed in the lower wall.

Clause 19: The peripheral connector of any of clauses 11 through 18, further including a set of protrusions formed in the at least one wall, wherein the set of protrusions includes a first protrusion and a second protrusion.

Clause 20: The peripheral connector of any of clauses 11 through 19, wherein the peripheral connector is a USB-C connector.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A peripheral connector comprising:
a body including:
an inner surface;
an outer surface opposite the inner surface; and
a set of recesses formed in the outer surface; and
a set of connection features extending outwardly from the body, wherein:
each connection feature of the set of connection features is disposed above the outer surface,
each connection feature of the set of connection features includes a first end and a second end opposite the first end,
for each connection feature, the first end and the second end are integrally formed in the outer surface,
each connection feature of the set of connection features is disposed above and spans across a corresponding recess of the set of recesses, and
each connection feature of the set of connection features at least partially covers the corresponding recess.

2. The peripheral connector of claim 1, wherein, even when flexed, each connection feature of the set of connection features remains disposed above the outer surface.

3. The peripheral connector of claim 1, wherein each connection feature of the set of connection features covers 50% of the corresponding recess.

4. The peripheral connector of claim 1, wherein each recess of the set of recesses extends through the inner surface.

5. The peripheral connector of claim 1, wherein each connection feature of the set of connection features defines a thickness that allows each connection feature to flex upon engaging a corresponding connector.

6. The peripheral connector of claim 5, wherein, when engaged with the corresponding connector, each connection feature of the set of connection features imparts a force on the corresponding connector.

7. The peripheral connector of claim 1, wherein:
the peripheral connector includes a first side and a second side opposite the first side, and
the set of connection features includes a first connection feature formed in the first side and a second connection feature formed in the second side.

8. The peripheral connector of claim 7, wherein the set of connection features includes:
a third connection feature formed in the first side, and
a fourth connection feature formed in the second side.

9. The peripheral connector of claim 1, further including a set of protrusions formed in the outer surface, wherein the set of protrusions includes a first protrusion and a second protrusion.

10. The peripheral connector of claim 1, wherein the peripheral connector is a USB-C connector.

11. A peripheral connector comprising:
a body defining a central axis, the body including:
at least one wall surrounding the central axis; and
a set of recesses formed in the at least one wall; and
a set of connection features extending outwardly from the body, wherein:
each connection feature of the set of connection features is disposed above the at least one wall,
each connection feature of the set of connection features includes a first end and a second end opposite the first end,
for each connection feature, the first end and the second end are integrally formed in the at least one wall,
each connection feature of the set of connection features is disposed above and spans across a corresponding recess of the set of recesses, and
each connection feature of the set of connection features at least partially covers the corresponding recess.

12. The peripheral connector of claim 11, wherein, even when flexed, each connection feature of the set of connection features remains disposed above the at least one wall.

13. The peripheral connector of claim 11, wherein each connection feature of the set of connection features covers 50% of the corresponding recess.

14. The peripheral connector of claim 11, wherein each recess of the set of recesses extends through the at least one wall.

15. The peripheral connector of claim 11, wherein each connection feature of the set of connection features defines a thickness that allows each connection feature to flex upon engaging a corresponding connector.

16. The peripheral connector of claim 15, wherein, when engaged with the corresponding connector, each connection feature of the set of connection features imparts a force on the corresponding connector.

17. The peripheral connector of claim 11, wherein:
the at least one wall includes an upper wall and a lower wall opposite the upper wall, and
the set of connection features includes a first connection feature formed in the upper wall and a second connection feature formed in the lower wall.

18. The peripheral connector of claim 17, wherein the set of connection features includes:
a third connection feature formed in the upper wall, and
a fourth connection feature formed in the lower wall.

19. The peripheral connector of claim 11, further including a set of protrusions formed in the at least one wall, wherein the set of protrusions includes a first protrusion and a second protrusion.

20. The peripheral connector of claim 11, wherein the peripheral connector is a USB-C connector.
